(19) United States
(12) Patent Application Publication
(10) Pub. No.: US 2007/0001802 A1
(43) Pub. Date: Jan. 4, 2007

(54) Electroplating method in the manufacture of the surface mount precision metal resistor

(76) Inventor: Ching Hsiung Hsieh, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/269,621

(22) Filed: Nov. 9, 2005

(30) Foreign Application Priority Data
Jun. 30, 2005 (TW) 094122011

(51) Int. Cl. H01C 1/012

(52) U.S. Cl. 338/309

(57) ABSTRACT

The present invention relates to an electroplating method in the manufacture of the surface mount precision metal resistor, the manufacturing steps are as below: a flat-shaped metal substrate strip being die stamped with predefined resistance value; separating said metal substrate strip into electroplating portion and non-electroplating portion by the separating insulator; removing the impurities on the surface of said electroplating portion by the electrolytic cleansing; insetting all flat-shaped metal substrate strips onto the vertical rotating bucket for electroplating to form two copper electrode terminals; removing off the separating insulator on said non-electroplating portion; grinding and surface roughness process on both of the upper and lower surfaces of said two copper electrode terminals; die stamping and cutting said electroplated metal substrate strip into metal resistor chip one by one; wrapping said non-electroplating portion on each said metal resistor chip with packaging layer; and roller-electroplating with tin-layer on the surfaces of said two copper electrode terminals at each said packaged metal resistor chip, thus the final product of the surface mount precision metal resistor having been completely manufactured.

### FIELD OF THE PRESENT INVENTION

The present invention relates to an electroplating method in the manufacture of the surface mount precision metal resistor, more particularly a chemical electroplating method to manufacture the surface mount precision metal resistor. By means of properly adjusting the current magnitude in electroplating process together with the rotational speed of the working resistor, the throughput can be proportionally expanded, thus, the productivity of the surface mount precision metal resistor can be substantially improved.

### BACKRGROUND OF THE PRESENT INVENTION

Due to the popularity of the global 3C electronic product and the requirement trend of lightweight, thin and small size in design, the demand quantity of the (SMT Resistor) is constantly increased. Currently, the monthly demand of the (SMT Resistor) in Taiwan exceeds 50 millions. But, local providers can only supply half of this demand so that importing (SMT Resistor) being still needed to offset the balance of that. Therefore, all the domestic and overseas manufacturers in the precision metal (SMT Resistor) render constantly all their efforts in improving relevant manufacturing process so as to meet the market demand. However, up to now, all the manufacturing process still fall into the mainstream category of various special manufacturing machines in automation, such as prior art in USA invention patents: U.S. Pat. No. 6,859,999; No. 6,725,529; No. 6,529,115; No. 6,510,605; No. 6,441,718; No. 6,401,329; No. 6,184,775; No. 6,148,502 and No. 5,999,085.

### SUMMARY OF THE PAST INVENTION

The primary object of the present invention is to provide a chemical electroplating method to manufacture the surface mount precision metal resistor. By means of properly adjusting the current magnitude in electroplating process together with the rotational speed of the working resistor, the throughput can be proportionally expanded, thus, the productivity of the surface mount precision metal resistor can be substantially improved. It is not only enabled to meet the market monthly productivity demand but also having decreased the total selling price as well as having flexible adaptability in producing product of special specifications. That is the principal object of the present invention.

### BRIEF DESCRIPTION OF THE DRAWINGS

FIG. 1 shows a flow chart of manufacture of the present invention.

FIG. 2 is a perspective illustrative view of the flat-shaped metal substrate strip.

FIG. 3 is a perspective illustrative view of the flat-shaped metal substrate strip with middle section being wrapped by separator.

FIG. 4 is a perspective illustrative view of the flat-shaped metal substrate strip being inset in the vertical rotating bucket of the present invention.

FIG. 5 shows a sectional view in utilizing the vertical rotating electroplating of the embodiment of the present invention.

FIG. 6 is a perspective illustrative view in operation of the metal substrate strip being removed off the separator of the present invention.

FIG. 7 is a perspective illustrative view of the metal substrate strip having been electroplated into copper electrode terminal of the present invention.

FIG. 7-A is a perspective illustrative view in operation of the copper electrode terminal on the metal substrate strip being ground of the present invention.

FIG. 8 is a perspective illustrative view of the metal resistor chip of the present invention.

FIG. 9 is a perspective illustrative view of the metal resistor chip having been packaged of the present invention.

FIG. 10 shows a sectional view of the packaged metal resistor chip in utilizing the horizontal rolling electroplating of the embodiment of the present invention.

FIG. 11 is a sectional view of the surface mount precision metal resistor of the present invention.

### DETAILED DESCRIPTION OF THE PREFERRED EMBODIMENTS

Following is the detailed description of the preferred specific embodiment of the present invention in association with illustrative figures.

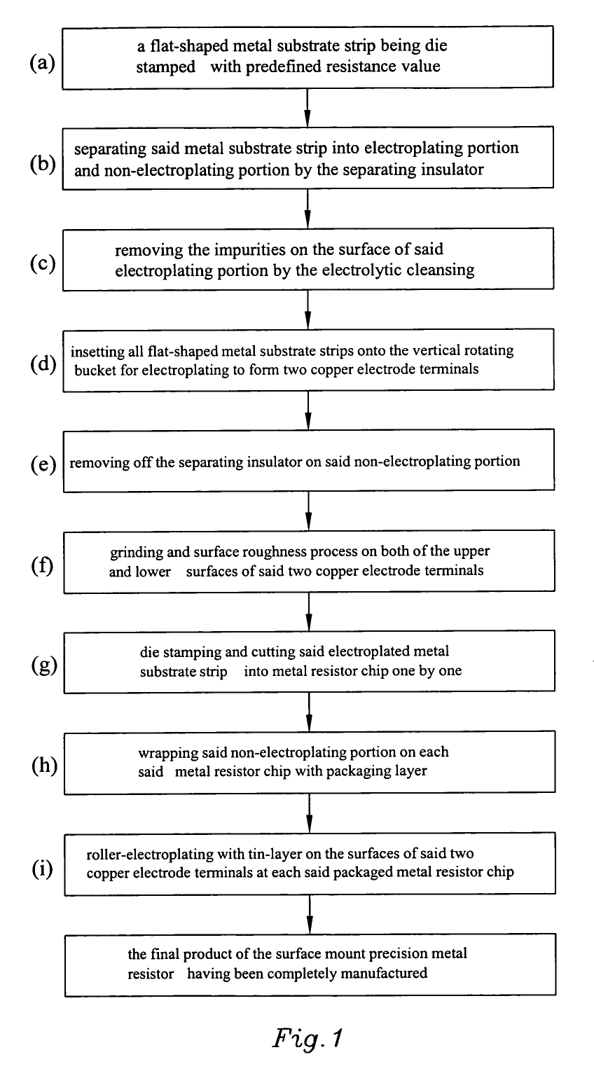

Refer to FIG. 1 through FIG. 11, the manufacturing steps of the electroplating method in the manufacture of the surface mount precision metal resistor are as below:

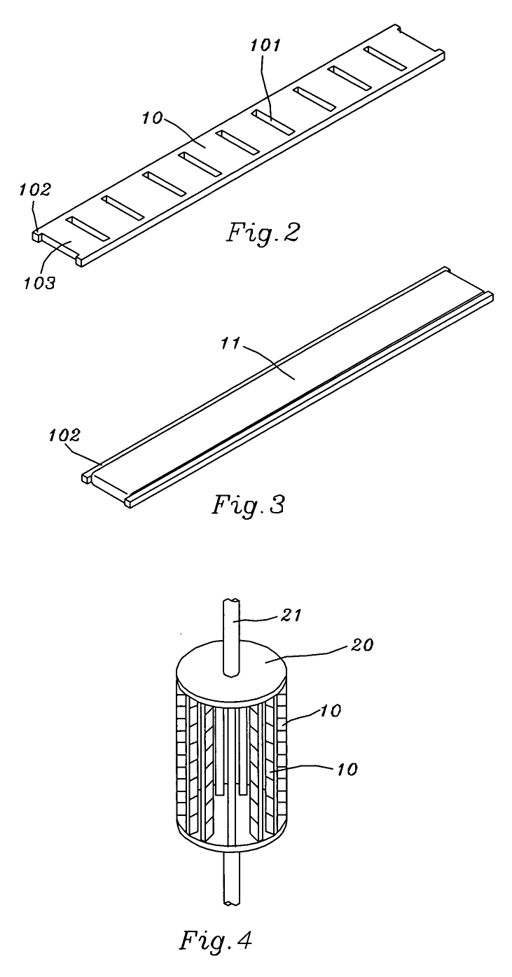

(a) According to the predefined resistance value (Ω), a flat-shaped metal substrate strip 10 with multiple rectangular holes 101 being die stamped in the manner of fixed interval such that its thickness being greater than 0.1 mm (as shown in the FIG. 2);

(b) By means of the acid-and-alkali-resisting adhesive tape 11 to serve as a separating insulator, completely wrapping the middle band of said metal substrate strip 10 to become as non-electroplating portion 103 and so that both of its lateral sides being become as electroplating portion 102 (as shown in the FIG. 3);

(c) Immerging said separating insulator wrapped metal substrate strip 10 into the electrolysis tank to purge, cleanse and rinse the impurities on the surface of said electroplating portion 102 orderly through four process of acid detergent cleansing, water cleansing, alkali detergent cleansing and water cleansing;

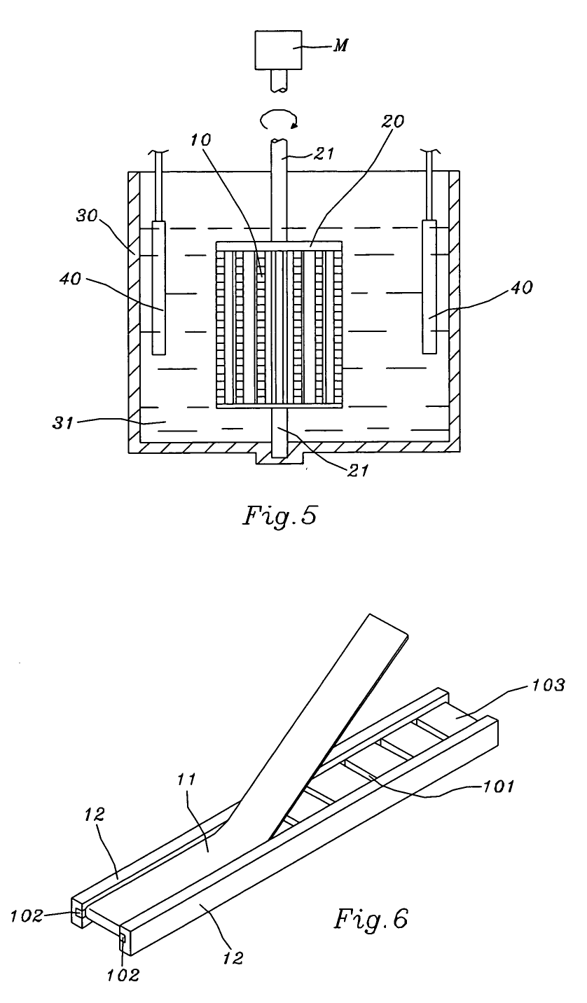

(d) Insetting said cleansed flat-shaped metal substrate strips 10 respectively onto the vertical rotating bucket 20 in order arrangement (as shown in the FIG. 4), then immerging it into the vertical electroplating tank 30 for electroplating, (as shown in the FIG. 5), wherein the electroplating liquid 31 and the pure copper metal educt 40 being contained so that two copper electrode terminals 12 being formed at said electroplating portion 102 on both lateral sides of said metal substrate strips 10 as the direct current being applied together with the corresponding rotation of the vertical rotating bucket 20 (as shown in the FIG. 6);

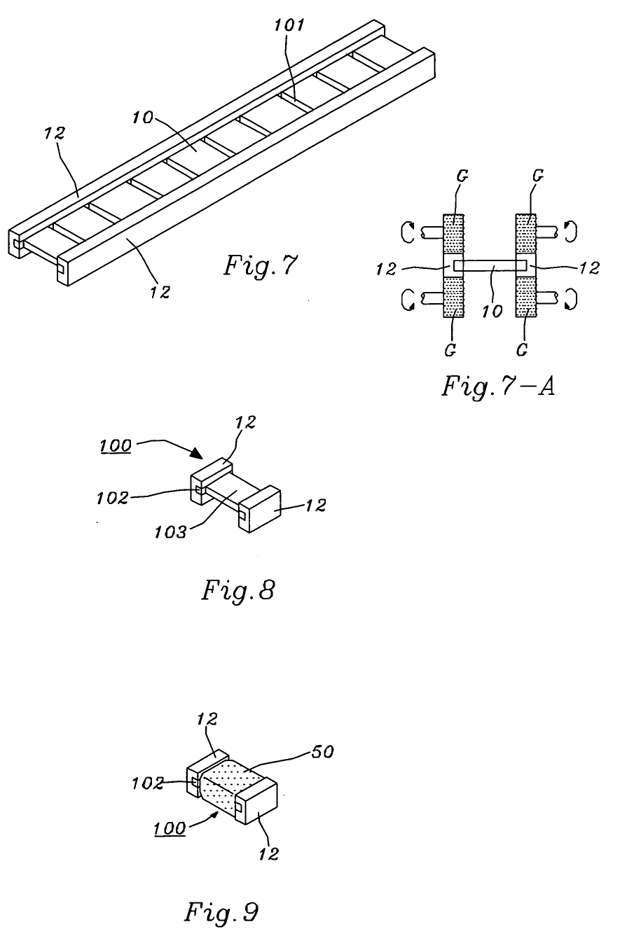

(e) Removing off the separating insulator of said acid-and-alkali-resisting adhesive tape 11, which completely wrapping the middle band of said metal substrate strip 10 having been electroplated (as shown in the FIG. 6 and the FIG. 7);

(f) Grinding both of the upper and lower surfaces of said two copper electrode terminals 12 on said electroplated metal substrate strip 10 such that its total thickness being greater than 0.5 mm and the range of its surface roughness being in 0.4 S˜0.8 S (as shown in the FIG. 7-A);

(g) According to the position of the rectangular hole 101 in said metal substrate strip 10, die stamping and cutting said electroplated metal substrate strip 10 into metal resistor chip 100 one by one (as shown in the FIG. 8);

(h) Wrapping said non-electroplating portion 103 on each said metal resistor chip 100 with high-temperature-resistant as well as acid-and-alkali-resisting packaging layer 50 (as shown in the FIG. 9); and

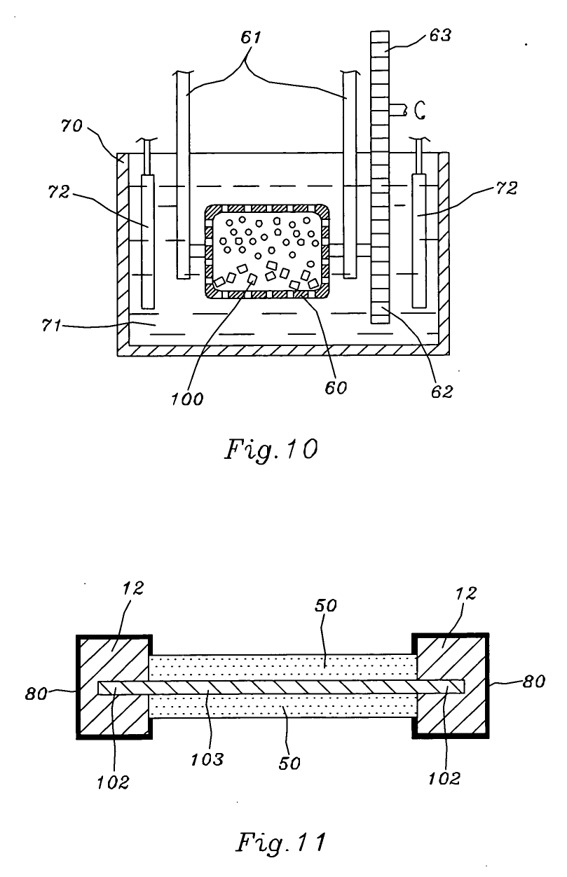

(i) Putting each said packaged metal resistor chip 100 into the horizontal roller 60, then moving it into the horizontal electroplating tank 70 for electroplating, (as shown in the FIG. 10), wherein the electroplating liquid 71 and the tin-metal educting rod being contained so that the tin electroplated layer 80 being rolling-electroplated on the surfaces of said two copper electrode terminals 12 at each said metal resistor chip 100 (as shown in the FIG. 11), thus the final product of the surface mount precision metal resistor having been completely manufactured.

In the foregoing step (a), said flat-shaped metal substrate strip 10 is alloy being formed by progressive die stamping; hence, the throughput can be limitlessly expanded in accordance with the instant production demand so as to satisfy with the requirement of the mass production; besides, said interval rectangular hole 101 can be contrived into oval hole to match with the size of said flat-shaped metal substrate strip 10, which being calculated out in accordance with the predefined resistance value (Ω). And, the separating insulator in the foregoing step (b) can be replaced by insulating paint being directly spread on the middle band of said metal substrate strip 10 to become as non-electroplating portion 103; and both of the lateral sides without insulating paint to become as electroplating portion 102; and the insulating paint can be easily removed by chemical solution after the completion of the electroplating.

Moreover, in the foregoing step (d), said metal educt 40, which being contained in said vertical electroplating tank 30 serves as positive electrode during electroplating reaction, can be replaced by other metal such as Nickel (Ni), palladium (Pd), platinum (Pt), Silver and gold.

Refer to FIG. 4 and FIG. 5, in the foregoing step (d), said vertical rotating bucket 20, which serves as negative electrode during electroplating reaction, has a rotating shaft 21 running through its center so as to inset into said vertical electroplating tank 30 for rotation; A motive power output apparatus M with adjustable rotational speed is coupled to the top end of said rotating shaft 21; by proper adjusting the rotational speed of said rotating shaft 21 on said vertical rotating bucket 20 in proportional to the magnitude of the current value in the electroplating, the time needed to let the tin electroplated layer 80 being rolling-electroplated on the surfaces of said two copper electrode terminals 12 can be substantially reduced so as to achieve the object of improving the throughput and productivity. In case of provisional demand of increasing the area of said copper electrode terminal 12, it can be met by directly adjusting the magnitude of the current value in the electroplating and the rotational speed of said vertical rotating bucket 20, thus it not only eliminates the extra working hour in the process but also meet the requirement of flexibility and adaptability in industrial mass production.

Refer to FIG. 7-A, the grinding on both of the upper and lower surfaces of said two copper electrode terminals 12 in the step (d) is done by two pairs of symmetrical and parallel grinding wheels G being juxtaposed so as to have one-time grinding process, hence, the parallelism and the surface roughness in both of the upper and lower surfaces of said two copper electrode terminals 12 in each said flat-shaped metal substrate strip 10 can meet the precise requirement, thus the process step can be effectively reduced so as to have the effect of achieving mass production.

Refer to FIG. 10 and FIG. 11, in the foregoing step (i), said horizontal roller 60, which being suspended by a bracket 61 and dipped in said horizontal electroplating tank 70 to served as negative electrode during electroplating reaction, has many porous on its wall to let said electroplating liquid 71 pass through; A horizontal shaft runs through said horizontal roller 60 such that one of its ends being coupled with a passive wheel 62, which being securely engaged with an external driving wheel 63, hence, said horizontal roller 60 can be constantly driven to roll so that the time in tin-electroplating on said copper electrode terminals 12 of all said metal resistor chip 100 in said horizontal roller 60 can be substantially decreased, thus the efficiency of tin-electroplating is relatively improved.

In summary, by means of properly adjusting the current magnitude in electroplating process together with the rotational speed of said vertical rotating bucket 20, the throughput can be proportionally expanded so that the productivity of the surface mount precision metal resistor can be substantially improved by its flexible adaptability in producing product of special specifications; it is not only enabled to meet the market monthly productivity demand but also decreases the total selling price, thus it really conforms to the patent essential criteria of industrial improvement and practical requirements.

What is claimed is:

1. An electroplating method in the manufacture of the surface mount precision metal resistor, said method comprising the following steps of:
(a) According to the predefined resistance value, a flat-shaped metal substrate strip with multiple rectangular holes being die stamped in the manner of fixed interval such that its thickness being greater than 0.1 mm;
(b) By means of the acid-and-alkali-resisting adhesive tape to serve as a separating insulator, completely wrapping the middle band of said metal substrate strip to become as non-electroplating portion and so that both of its lateral sides being become as electroplating portion;
(c) Immerging said separating insulator wrapped metal substrate strip into the electrolysis tank to purge, cleanse and rinse the impurities on the surface of said electroplating portion orderly through four process of acid detergent cleansing, water cleansing, alkali detergent cleansing and water cleansing;
(d) Insetting said cleansed flat-shaped metal substrate strips respectively onto the vertical rotating bucket in order arrangement, then immerging it into the vertical electroplating tank for electroplating, wherein the electroplating liquid and the pure copper metal educt being contained so that two copper electrode terminals being formed at said electroplating portion on both lateral sides of said metal substrate strips as the direct current being applied together with the corresponding rotation of the vertical rotating bucket;
(e) Removing off the separating insulator of said acid-and-alkali-resisting adhesive tape, which completely wrapping the middle band of said metal substrate strip having been electroplated;
(f) Grinding both of the upper and lower surfaces of said two copper electrode terminals on said electroplated metal substrate strip such that its total thickness being greater than 0.5mm and the range of its surface roughness being in 0.4 S˜0.8 S;
(g) According to the position of the rectangular hole in said metal substrate strip, die stamping and cutting said electroplated metal substrate strip into metal resistor chip one by one;
(h) Wrapping said non-electroplating portion on each said metal resistor chip with high-temperature-resistant as well as acid-and-alkali-resisting packaging layer; and
(i) Putting each said packaged metal resistor chip into the horizontal roller then moving it into the horizontal electroplating tank for electroplating, wherein the electroplating liquid and the tin-metal educting rod being contained so that the tin electroplated layer being rolling-electroplated on the surfaces of said two copper electrode terminals at each said metal resistor chip.

2. A method, as recited in claim 1, wherein said flat-shaped metal substrate strip of the step (a) is a alloy and being formed by progressive die stamping.

3. A method, as recited in claim 1, wherein said interval rectangular hole of said flat-shaped metal substrate strip of the step (a) is contrived into oval hole.

4. A method, as recited in claim 1, wherein said separating insulator of the step (b) is further replaced by insulating paint being directly spread on the middle band of said metal substrate strip to become as non-electroplating portion; and both of the lateral sides without insulating paint to become as electroplating portion.

5. A method, as recited in claim 1, wherein said metal educt of said vertical electroplating tank of the step (d) is further replaced by other metal such as anyone of Nickel (Ni), palladium (Pd), platinum (Pt), Silver and gold.

6. A method, as recited in claim 1, wherein said vertical rotating bucket of the step (d) having a rotating shaft running through its center and further with a motive power output apparatus therein;

7. A method, as recited in claim 1, wherein said grinding on both of the upper and lower surfaces of said two copper electrode terminals of the step (d) is done by two pairs of symmetrical and parallel grinding wheels being juxtaposed.

8. A method, as recited in claim 1, wherein said horizontal roller of the step (i), which being suspended by a bracket in said horizontal electroplating tank, and has many porous on its wall and a horizontal shaft runs through said horizontal roller such that one of its ends being coupled with a passive wheel, which being securely engaged with an external driving wheel.
